(19) United States
(12) Patent Application Publication
(10) Pub. No.: US 2006/0123454 A1
(43) Pub. Date: Jun. 8, 2006

(54) Methods and apparatus for transmitting user selections to a host location in an interactive communication system

(76) Inventor: Ovidiu Octavian Popa, Toronto (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/002,096

(22) Filed: Dec. 3, 2004

(51) Int. Cl. H04N 7/16; H04N 7/173; H04H 9/00

(52) U.S. Cl. 725/120; 725/9

(57) ABSTRACT

A method for execution by customer equipment capable of communication with a user. The method comprises collecting user data, storing the user data in a memory scheduling execution of a data send application at a time later than the current time. The data send application comprises computer-readable instructions for causing transmission of the user data to a host. The data send application may be downloaded into the memory, or it may already reside in the memory before the user data is collected. Also, there is disclosed a customer device, with a user interface for collecting user data, a memory and a control unit adapted to execute computer-readable instructions for storing the collected user data into the memory and scheduling execution of a data send application at a time later than the current time. Thus, the transmission of votes and other information can be delayed until a time frame where resource usage is statistically lower.

### FIELD OF THE INVENTION

The present invention relates generally to telecommunications and, in particular, to methods and apparatus for transmitting selections made by a user of an interactive communication system, such as an interactive television system, to a central location.

### BACKGROUND

Interactive television is an emerging field, with possibilities far exceeding those of conventional (i.e., one-way) television. One of the features of Interactive television is the ability to solicit and gather viewer input to specific queries. Examples of data gathering include conducting political polls during a newscast, obtaining viewer preferences during a talent contest, and so on. One way in which this information can be collected is through the use of a set-top box at the customer premises, which is connected to a viewer's television set. At a specified moment during a broadcast, the set top box displays a pop-up on a television screen while the viewer is watching a particular television channel. The pop-up presents a plurality of choices. The viewer opts for one of the choices by pressing one or more keys on a remote control device. The set top box collects the “vote” that has been cast by the viewer and the pop-up disappears from the screen.

The set top box then has the job of transmitting the vote to a central location so it can be tallied. This is the point at which television becomes truly interactive by requiring two-way communications. In a satellite-based system, which employs a communication medium that is inherently one-way, the requirement for interactivity is met by equipping the set top box with a modem that is connected to a residential telephone line. Thus, when a vote is cast by a viewer, the set top box instructs the modem to dial a designated telephone number.

Conventionally, the telephone number dialed by the modem is related to the result of the vote. In other words, different selections made by the viewer will cause the modem to dial different telephone numbers. As soon as the telephone number is dialed and the call is answered at that telephone number, the call is dropped. A computer counts the number of calls dropped, which translates into a number of votes cast for a particular option. The numbers of votes cast for the various options are then gathered by a central database for statistical purposes.

Since interactive television is a relatively new phenomenon, viewers may be reluctant to cast votes when asked to do so. In order to encourage viewers to cast votes, the television content provider may offer a prize. In order to give away the prize, information needs to be collected about each viewer so as to allow a winning viewer to be identified. For this reason, the above-described drop call technique is insufficient. Rather, a lengthier and more complex exchange of information needs to be performed at the time that a given set top box transmits a vote to a host modem.

However, the need for a lengthier exchange with the host modem leads to a severe capacity bottleneck. Specifically, consider the fact that all viewers of a particular television channel will simultaneously receive a pop-up on their screens and that these viewers will all vote during approximately the same period of time. Consequently, multiple set top boxes may dial the same telephone number during a common time interval. However, the number of host modems in a given modem bank is limited. Thus, given that the exchange of information lasts a certain amount of time, there is a possibility that the number of attempted calls at a critical time exceeds the total number of host modems in a given modem bank. As a result, there may be an inaccuracy in the number of votes counted, or a viewer's telephone line may be occupied for an unacceptable amount of time due to multiple failed attempts at dialing a particular telephone number.

Against this background, it is clear that the interactive television industry is in need of an improvement in the way in which the results of viewer input are transmitted to a central location.

### SUMMARY OF THE INVENTION

In accordance with a first broad aspect, the present invention may be summarized as a method for execution by customer equipment capable of communication with a user. The method comprises collecting user data, storing the user data in a memory and scheduling execution of a data send application at a time later than the current time. The data send application comprises computer-readable instructions for causing transmission of the user data to a host.

In accordance with a second broad aspect, the present invention may be summarized as a method for execution by a plurality of customer devices capable of communication with respective users. The method comprises collecting respective user data from the respective users, storing the respective user data in respective memories and scheduling execution of a plurality of data send applications at respective execution times. The data send applications comprise respective computer-readable instructions for causing transmission of the respective user data to a host.

In accordance with a third broad aspect, the present invention may be summarized as computer-readable media tangibly embodying instructions for execution by a control unit in a customer device to perform a method, the control unit having access to a memory, the method comprising collecting user data, storing the user data in the memory, and scheduling execution of the data send application at a time later than the current time. The data send application comprises second computer-readable instructions for causing transmission of the user data to a host.

In accordance with a fourth broad aspect, the present invention may be summarized as a customer device, which comprises a user interface for collecting user data from a user of the customer device, a memory, and a control unit adapted to execute computer-readable instructions for storing the collected user data into the memory and scheduling execution of a data send application at a time later than the current time.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram showing an interactive television system, including a digital set top box;

FIG. 2 is a block diagram showing the contents of a memory in the set top box of FIG. 1;

FIG. 3 shows the steps in a channel control application executed by a control unit in the set top box of FIG. 1;

FIG. 4 shows the steps in a voting application executed by the control unit;

FIG. 5 shows the steps in a data send application executed by the control unit;

FIG. 6 shows how deferred execution of the data send application can be distributed over an extended time frame among a plurality of set top boxes.

### DETAILED DESCRIPTION

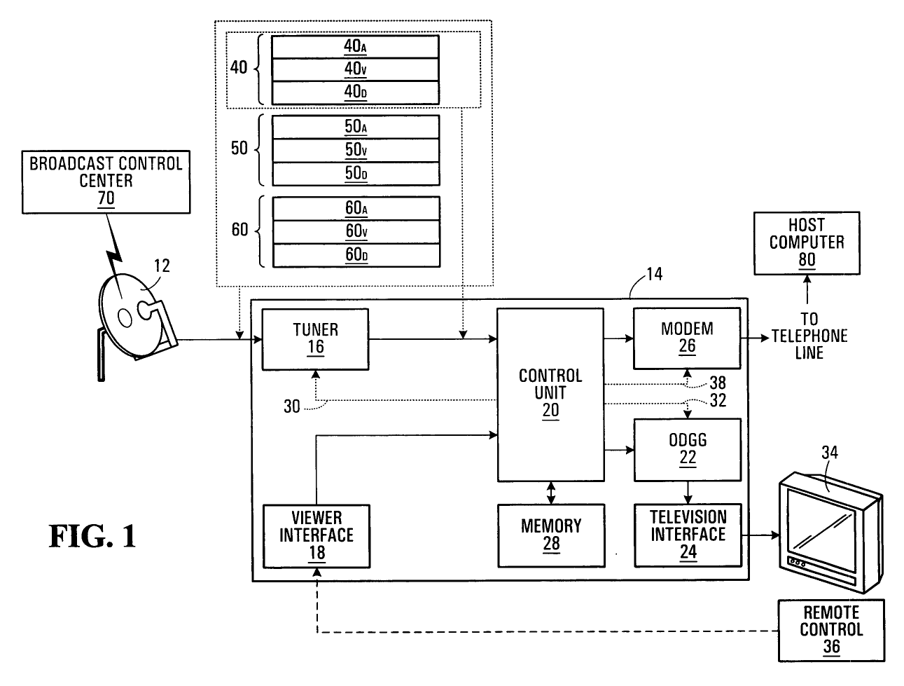

In accordance with a non-limiting embodiment of the present invention, FIG. 1 shows an example of an interactive television system in which customer equipment delivers an interactive television service to a viewer. The customer equipment comprises a satellite receiver (dish) 12 and a digital set top box 14. The set top box 14 comprises a tuner 16, a viewer interface 18, a control unit 20, an on-screen display and graphics generator (ODGG) 22, a television interface 24 and a modem 26. The control unit 20, which may be implemented as a microprocessor and/or an application-specific integrated circuit (ASIC), has access to a memory 28. The memory 28 comprises a plurality of blocks whose purpose and function will be described in some detail later on.

The satellite dish 12 captures a broadcast signal emitted by a broadcast control center 70 and forwarded by a satellite (not shown) orbiting the Earth. The broadcast signal comprises a plurality of channels 40, 50, 60, each of which comprises audio-video content. The audio-video content for a given channel may occupy one or more sub-channels (subscripts A and V). In addition, any given channel may also comprise one or more data sub-channels (subscript D) that carries data intended for the set top box 14. Without limiting the scope of the present invention, the one or more data sub-channels are hereinafter referred to in the singular.

The received broadcast signal is fed to the tuner 16. Among the various channels captured by the satellite dish 12, only a subset (e.g., one or two) correspond to channels that have been selected by a viewer. The identity of the selected channel(s) will be indicated by a tuning signal 30 from the control unit 20. Assuming for simplicity that there is a single selected channel, namely channel 40, the tuner 16 filters the received broadcast signal to allow passage of the associated audio-video channels 40_{A}, 40_{V} and the associated data sub-channel 40_{D}.

The control unit 20 processes the digital signal received from the tuner 16, with the audio-video sub-channels 40_{A}, 40_{V} of the selected channel 40 being output to the ODGG 22. The ODGG 22, under the control of a graphics signal 32 from the control unit 20, modifies the digital signal to introduce certain visual elements, such as a pop-up. The ODGG 22 sends the modified digital signal to the television interface 24, which effects conversion of the digital signal into a format suitable for viewing on a television display 34. This format may be analog or digital, depending on the type of display 34.

The data sub-channel 40_{D} received from the tuner 16 is also processed by the control unit 20. The data carried in the data sub-channel 40_{D} can include the information to be displayed in a pop-up that is presented to the viewer. The data carried in the data sub-channel 40_{D} may be stored in the memory 28 in a manner to be described in greater detail later on.

Continuing with the description of the set top box 14 in FIG. 1, the viewer interface 18 captures viewer input, typically effected via a remote control device 36 such as an infrared console, a wireless mouse or other device. The viewer interface 18 may thus have a wireless component, but it is not restricted to such. Examples of viewer input include but are not limited to selecting a channel, programming a personal video recording function, casting a vote, and so on.

Some forms of viewer input influence the tuning signal 30 supplied by the control unit 20 to the tuner 16. Specifically, when the viewer identifies a selected channel to be viewed on the display 34, the identity of the selected channel is captured by the viewer interface 18 and sent to the control unit 20, which in turn generates the tuning signal 30, causing the tuner 16 to allow passage of the digital signal associated with the selected channel.

Other forms of viewer input are the result of the interactive nature of the system of FIG. 1. Specifically, in response to viewing a pop-up, a viewer may enter a selection on the remote control device 36. The selection is captured by the viewer interface 18, which is then sent to the control unit 20. The control unit 20 interprets the viewer selection and may cause the selection to be reflected in the visual elements applied by the ODGG 22. In addition, and as will be described in greater detail later on in this specification, the viewer selection is stored in the memory 28 for transmission outside the set top box 14 with the aid of the modem 26.

The modem 26 is connected to a telephone line in the viewer's home via a telephone jack (e.g., RJ-11). The modem 26 can be controlled by a modem control signal 38 from the control unit 20, which causes it to dial a given telephone number and establish a communication link with a remote modem. The remote modem need not be located at the broadcast control center 70. For example, the remote modem could be reachable via a toll-free number, which may be answered at a call center separate from the broadcast control center 70. For the purposes of this discussion, let the remote modem be part of a modem bank hereinafter referred to as a host computer 80 and let the location of the host computer 80 be hereinafter referred to as a host location. Thus, it will be seen that the modem 26 is used to send to the host computer 80 the viewer input, which is collected by the control unit 20 in response to a particular pop-up, or during ordinary usage of the set top box 14.

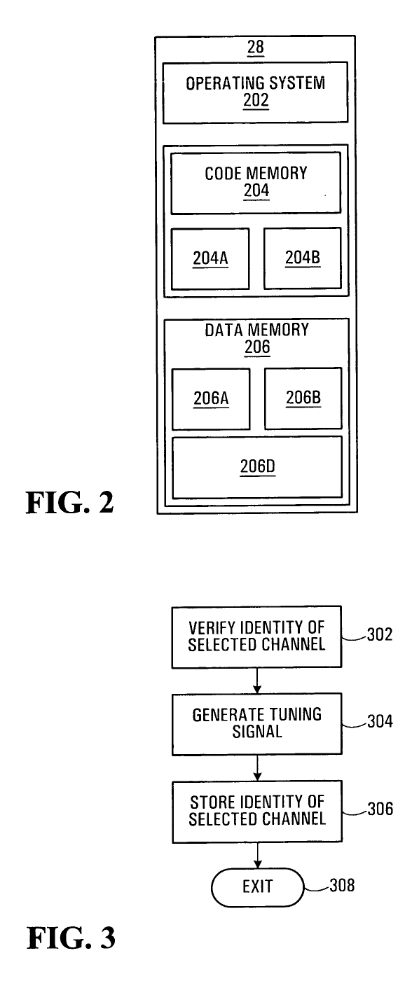

It will be appreciated that the control unit 20 plays an important role in rendering the viewing experience interactive. Accordingly, and with additional reference to FIG. 2, it may be useful to describe in greater detail the functionality of the control unit 20. Specifically, the control unit 20 runs an operating system or kernel, residing in a reserved block of the memory 28 (“memory block”), denoted 202.

The operating system is responsible for executing basic applications upon detection of stimuli, which may be carried in the signals received from the tuner 16 or the viewer interface 18, for example. These basic applications reside in respective blocks of a code memory 204 as sets of computer-readable program instructions. Two of the applications that can be stored in respective blocks 204A, 204B of the code memory 204 include a “channel change” application and a “voting” application. Each of these applications will be described in greater detail herein below. Other applications that may be executed by the control include but are not limited to an event programming application and a session management application.

The operating system also has the responsibility to execute certain other applications at specific times in the future. These can be referred to as scheduled applications. Rather than being stored in the code memory 204, the scheduled applications can reside anywhere in the memory 28, including in a series of blocks 206A, 206B of a data memory 206. In accordance with an embodiment of the present invention, the scheduled applications are executed “blindly”, i.e., under the assumption that a particular block containing the application scheduled for execution comprises valid program instructions.

For completeness, the data memory 206 comprises a further block 206D, which is used for storing data and other variables used during execution of the control unit 20.

Those skilled in the art will appreciate that either or both of the code memory 204 and the data memory 206 could comprise a medium which is fixed, tangible and readable directly by the control unit 20 (e.g., electrically erasable programmable read-only memory (EEPROM), flash memory, removable diskette, CD-ROM, ROM, or fixed disk). Alternatively, either or both of the code memory 204 and the data memory 206 could be stored remotely but transmittable to the control unit 20 via a modem or other interface device (e.g., a communications adapter) connected to a network over a transmission medium.

Details regarding the channel change application are now provided with reference to FIG. 3. The associated program instructions stored in block 204A of the code memory 204 are executed upon detection of a signal from the viewer interface 18 which indicates the viewer's intent to select a channel.
Step 302: The control unit 20 verifies that the identity of the selected channel 40 is different form the one currently being viewed. The identity of the channel currently being viewed can be found in block 206D of the data memory 206 (see step 306). If the selected channel 40 is indeed different, the control unit 20 proceeds to step 304.
Step 304: The control unit 20 generates the tuning signal 30 in order to cause the tuner 16 to allow passage of the audio, video and data sub-channels 40_{A}, 40_{V}, 40_{D} associated with the selected channel 40.
Step 306: The control unit 20 stores the identity of the selected channel 40 in block 206D of the data memory 206 for future reference (see step 302).
Step 308: The control unit 20 exits the channel change application and returns control to the operating system.

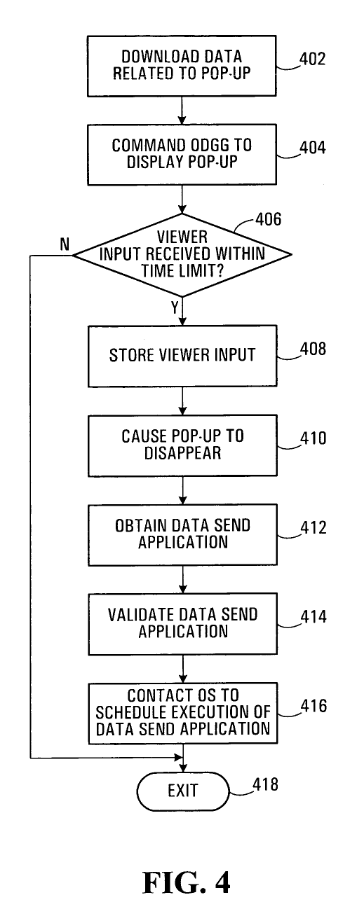

Details regarding the voting application are now provided with reference to FIG. 4. The associated program instructions stored in block 204B of the data memory 204 are executed upon detection of a marker in one or the other or both of the audio and video sub-channels 40_{A}, 40_{V} of the selected channel 40, as received from the tuner 16. Such a marker could be inserted by the broadcast control center 70 when it is desired that a pop-up be displayed in order to solicit viewer input on a particular subject.
Step 402: The control unit 20 downloads data related to the pop-up into block 206D of the data memory 206. Specifically, the control unit 20 waits for this data to arrive from the tuner 16 on the data sub-channel 40_{D} of the selected channel 40. The data related to the pop-up includes data to be displayed on the screen 34, and may also include a time limit by which the viewer is required to cast a vote.
Step 404: The control unit 20 commands the ODGG 22 to display a pop-up using the received data related to the pop-up. From a graphical point of view, the pop-up may take on a variety of forms, including a table, grid, array, etc.
Step 406: The control unit 20 monitors the viewer interface 18 for viewer input. Viewer input is detected when the signal received from the viewer interface 18 indicates that the viewer has made a selection. If viewer input is detected, the control unit proceeds to step 408; if viewer input is not detected, the control unit 20 continues executing step 406, as long as the time limit has not expired.
Step 408: The control unit 20 stores the viewer input in block 206D of the data memory 206. The viewer input may comprise an indication of a vote, selection, etc. In addition, the control unit 20 may store information related to the time at which the viewer input was received or stored.
Step 410: The control unit 20 modifies the graphics signal 32 fed to the ODGG 22 such that the pop-up disappears from the display 34. This step may be executed in response to the viewer having made a selection or may be executed automatically after expiry of the time limit by which the viewer is permitted to supply viewer input.
Step 412: The control unit 20 downloads program instructions related to a “data send” application into block 206A of the data memory 206. Specifically, the control unit 20 waits for these instructions to arrive from the tuner 16 on the data sub-channel 40_{D} of the selected channel 40. It is assumed that the broadcast control center 70 will indeed send the instructions.
Step 414: The control unit 20 verifies that the program instructions related to the data send application are valid. This does not imply execution of the instructions, only validation so as to ensure that the control unit 20 will likely not crash if it were to execute the contents of block 206A of the data memory 206. This step is of course optional, but can be advantageous when the integrity of the received instructions is questionable.
Step 416: The control unit 20 communicates with the operating system to schedule execution of the data send application (i.e., the contents of block 206A of the data memory 206) at time later than the current time.
Step 418: The control unit 20 exits the voting application and returns control to the operating system.

In an alternative embodiment, steps 412 and 414 can be skipped over, i.e., after collecting data from the viewer, the control unit 20 proceeds to step 418, where deferred execution of the data send application is scheduled. In this case, instead of the control unit 20 downloading the program instructions related to the data send application into block 206A of the data memory 206, these program instructions may be pre-loaded in block 206A of the data memory 206 or elsewhere in the data memory 206.

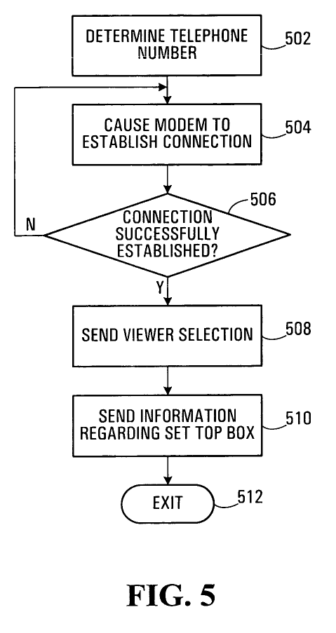

Details regarding the data send application are now provided with reference to FIG. 5. The associated program instructions stored in block 206A of the data memory 206 are executed at the scheduled time, i.e., as established at step 416 of the voting application. It is within the scope of the present invention to abort another subroutine that the control unit 20 may be executing when the time comes to execute the data send application.
Step 502: The control unit 20 determines a telephone number for the modem 26 to dial. The telephone number identifies the location where the host computer 80 can be reached. In one embodiment, the telephone number may be a pre-determined telephone number to be used irrespective of the viewer input collected, whereas in other embodiments, a different telephone number may be dialed, depending on the input received from the viewer.
Step 504: The control unit 20 causes the modem 26 to dial the selected telephone number and establish a connection with the host computer 80.
Step 506: The control unit 20 waits for confirmation of successful establishment of the connection. If the connection is not successfully established, the control unit 20 reverts to step 504, where the connection is re-attempted; when the connection is successfully established, the control unit 20 proceeds to step 508.
Step 508: The control unit 20 causes the modem 26 to send the viewer selection, which is stored in block 206D of the data memory 206.
Step 510: The control unit 20 optionally causes the modem 26 to send an identifier associated with the set top box 14. This could be a hardware identifier, such as a MAC-ID, global unique identifier (GUID) or serial number of the set top box or one or more components thereof. This information is used in order to enable the host computer 80 to associate received votes with subscribers, thereby facilitating the distribution of prizes, etc.
Step 512: The control unit 20 exits the data send application and returns control to the operating system.

It will thus be seen that the ability to schedule execution of the data send application at a desired time in the future can be used to delay the transmission of votes and other information until a time frame where usage of the telephone line (or the host computer 80 or the set top box 14) is statistically lower.

It should be appreciated that the scheduled execution time for the data send application may be deliberately varied from one set top box to another. For example, the scheduled execution time for the data send application can be randomized to occur with approximately equal likelihood anywhere in a given time frame of low statistical usage of the telephone line (or the host computer 80 or the set top box 14). An example of suitable time frame is between midnight and 6 AM, or between 1 AM and 5 AM, or between 2 AM and 4 AM, all times local to where the set top box is located.

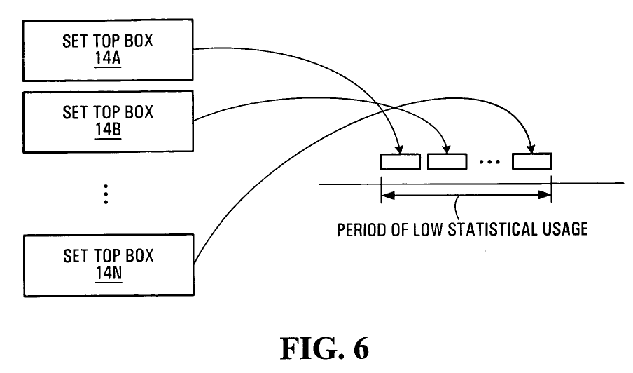

With additional reference to FIG. 6, randomization across an ensemble of set top boxes 14A, 14B, . . . , 14N can be effected by performing a random number generation function as part of step 416 described above. The random number generation function can utilize a seed that is taken in part from a MAC-ID, global unique identifier or serial number for each set top box in the ensemble of set top boxes 14A, 14B, . . . , 14N. This will ensure that the host computer 80 is contacted in a more uniform manner by the ensemble of set top boxes 14A, 14B, . . . , 14N when each executes its own instantiation of the data send application.

It will be appreciated that once the viewer has made a selection in response to a pop-up, the selected channel may be changed. In other words, after executing the voting application, the operating system may execute the channel change application before executing the data send application. This scenario, which is quite likely to occur since the data send application may not execute until the early morning hours, is perfectly acceptable, since the data send application remains stored in a different portion of the memory 28, namely block 206A of the data memory 206.

Now, consider the case where the viewer has voted while viewing channel 40, then changes to channel 50 and is presented with another opportunity to vote before the data send application has had a chance to execute. This scenario can be handled in many ways.

In a first variant, the same voting application as previously described will be triggered by a marker in one or more of the audio and video sub-channels 50_{A}, 50_{V} of the selected channel 50. This will result in the receipt of program instructions for executing a second data send application. However, instead of storing these new instructions in block 206A of the data memory 206, they will be stored in a different portion of the memory 28, such as block 206B of the data memory 206.

In order to allow the control unit 20 to determine where to store a given set of received instructions, be they for the first or second data send application, an additional step may be executed between steps 410 and 412, whereby the control unit 20 verifies, in a certain order, whether each of the available memory blocks (in this case blocks 206A and 206B of the data memory 206) are full, in search of the first vacant code memory block.

Of course, in an alternative embodiment, the first and second data send applications may be pre-loaded in the memory 206 and hence there would be no need to download them from the broadcast control center 70.

Continuing with the scenario where multiple data send applications (either downloaded or pre-loaded) need to be executed at a later time, there may be an additional benefit to stagger the execution times of the various data send applications so as not to conflict internally at the set top box 14. Thus, the operating system can have final control over the scheduled execution times of multiple data send applications stored in multiple memory blocks.

It has been assumed in the foregoing that the contents of blocks 204A, 204B of the code memory 204 containing the channel change operation and the voting application, respectively, are pre-determined at the time that the relevant triggering event occurs. This does not imply that the contents of these blocks of the code memory 204 is fixed. In other words, it is within the scope of the present invention to allow the contents of blocks 204A, 204B, which store the channel change application and the voting application, to be dynamically changed (e.g., by an act of downloading), thus offering the ability to upgrade the applications.

Also, although only two blocks 204A, 204B of the code memory 204 and two blocks 206A, 206B of the data memory 206 have been referred to in the above, it is to be understood that the number of blocks in either or both of the code memory 204 and the data memory 206 can be selected to match or exceed the number of applications needed to be run by the control unit 20. Moreover, the distinction between data memory and code memory is made for convenience only, as it is possible to utilize a memory 206 that has a plurality of blocks of a more generic nature.

Moreover, although the above description has focused on implementation of the invention using a digital set top box, it should be understood that the present invention could be applied to the collection of viewer input using a residential gateway, cable modem or other device used for delivering an interactive television service. Moreover, the present invention could be applied outside the realm of interactive television in order to collect input from users of other media, such as cellular telephones and personal computers. Generally speaking, it is within the scope of the present invention to use any device that is capable of inviting a user to input information that is to be sent to a central location where the information is processed.

Furthermore, it will be appreciated that where the customer equipment is a residential gateway, the host computer may be contactable via an Internet Protocol (IP) address over a digital communication link. Thus, the modem 26 can be replaced by an interface that is capable of communicating with the host computer and establishing a connection (e.g., an IP session or a Point-to-Point-over-Ethernet (PPPoE) session) therewith over the digital communication link.

While specific embodiments of the present invention have been described and illustrated, it will be apparent to those skilled in the art that numerous | modifications and variations can be made without departing from the scope of the invention as defined in the appended claims.

What is claimed is:

1. A method for execution by customer equipment capable of communication with a user, comprising:
collecting user data;
storing the user data in a memory;
scheduling execution of a data send application at a time later than the current time, the data send application comprising computer-readable instructions for causing transmission of the user data to a host.

2. The method defined in claim 1, further comprising downloading the data send application into the memory.

3. The method defined in claim 1, wherein the data send application resides in the memory before the user data is collected.

4. The method defined in claim 1, wherein collecting user data comprises receiving an indication of the user's intent to send the user data.

5. The method defined in claim 4, further comprising:
presenting to the user an option to send the user data by making a selection on a remote control device;
wherein the step of receiving an indication of the user's intent to send the user data is executed in response to the step of presenting.

6. The method defined in claim 5, further comprising receiving audio-video content from a source and relaying the received audio-video content to the user.

7. The method defined in claim 6, wherein the audio-video content comprises a marker implanted by the source, the method further comprising:
detecting the marker;
wherein the step of presenting to the user an option to send the user data is executed in response to the step of detecting the marker.

8. The method defined in claim 7, further comprising downloading the data send application into the memory subsequent to detecting the marker.

9. The method defined in claim 1, further comprising:
presenting to the user an option to send the user data by making a selection on a remote control device within a predetermined amount of time;
wherein the step of collecting user data is executed in response to the step of presenting, and is executed only during the predetermined amount of time.

10. The method defined in claim 1, wherein collecting user data comprises receiving an indication of at least one selection made by the user via a remote device.

11. The method defined in claim 10, wherein the at least one selection made by the user via a remote control device comprises a response to a survey.

12. The method defined in claim 10, wherein the at least one selection made by the user via a remote control device comprises a vote.

13. The method defined in claim 10, wherein the at least one selection made by the user via a remote control device comprises a channel selection.

14. The method defined in claim 1, wherein collecting user data comprises receiving an indication of selections made by the user via a remote control device and an indication of the time instants at which the selections were made.

15. The method defined in claim 1, wherein the memory is a flash memory.

16. The method defined in claim 1, further comprising:
at the scheduled time, executing the data send application.

17. The method defined in claim 16, wherein executing the data send application comprises executing the computer-readable instructions for causing transmission of the user data to the host.

18. The method defined in claim 16, wherein executing the data send application further comprises transmitting identification information to the host.

19. The method defined in claim 18, wherein the identification information comprises an identifier of the customer equipment.

20. The method defined in claim 19, wherein the identifier of the customer equipment comprises at least one of a MAC ID, a serial number and a global unique identifier (GUID).

21. The method defined in claim 1, further comprising validating the data send application.

22. The method defined in claim 21, wherein validating the data send application comprises verifying executability of the instructions that comprise the data send application.

23. The method defined in claim 1, wherein scheduling execution of the data send application at a time later than the current time is preceded by determining the time at which to schedule the execution of the data send application.

24. The method defined in claim 23, wherein determining the time at which to schedule the execution of the data send command comprises execution of a random number generation process.

25. The method defined in claim 24, wherein the random number generation process utilizes a seed related to an identifier of the customer equipment.

26. The method defined in claim 25, wherein the identifier of the customer equipment comprises at least one of a MAC ID, a serial number and a global unique identifier (GUID).

27. The method defined in claim 24, wherein the time later than the current time is restricted to being between either (I) midnight and six A.M.; (II) one A.M. and five A.M.; or (III) two A.M. and four A.M. local time where the customer equipment is located.

28. The method defined in claim 1, wherein the computer-readable instructions of the data send application comprise:
computer-readable instructions for establishing a connection with the host;
computer-readable instructions for sending the user data to the host in response to successful establishment of the connection with the host.

29. The method defined in claim 28, further comprising storing host location information at a pre-determined location in the memory.

30. The method defined in claim 29, wherein the computer-readable instructions for establishing a connection with the host comprise computer-readable instructions for contacting the host using the host location information.

31. The method defined in claim 30, further comprising, prior to storing the host location information, receiving the host location information from a source.

32. The method defined in claim 30, wherein the host location information comprises a telephone number at which the host can be reached.

33. The method defined in claim 32, wherein the telephone number is a toll-free telephone number.

34. The method defined in claim 30, wherein the host location information comprises an Internet Protocol address at which the host can be reached.

35. The method defined in claim 34, wherein the connection is an Internet Protocol session.

36. The method defined in claim 34, wherein the connection is a Point-to-Point-over-Ethernet session.

37. The method defined in claim 28, wherein the host is selected from a group consisting of a plurality of hosts.

38. The method defined in claim 37, wherein the selected one of the plurality of pre-determined host locations is a function of the user data.

39. The method defined in claim 38, further comprising storing host location information at a pre-determined location in the memory.

40. The method defined in claim 39, wherein the computer-readable instructions for establishing a connection with the host comprise computer-readable instructions for contacting the host using the host location information.

41. The method defined in claim 40, further comprising, prior to storing the host location information, receiving the host location information from a broadcast control center.

42. The method defined in claim 40, wherein the host location information comprises a telephone number at which the host can be reached.

43. The method defined in claim 42, wherein the telephone number is a toll-free telephone number.

44. The method defined in claim 40, wherein the host location information comprises an Internet Protocol address at which the host can be reached.

45. The method defined in claim 44, wherein the connection is an Internet Protocol session.

46. The method defined in claim 44, wherein the connection is a Point-to-Point-over-Ethernet session.

47. The method defined in claim 1, wherein the customer equipment comprises a satellite receiver integrated with a modem.

48. The method defined in claim 2, wherein downloading the data send application into the memory comprises receiving the computer-readable instructions of the data send applications from a broadcast control center.

49. The method defined in claim 1, wherein the customer equipment comprises a set top box.

50. The method defined in claim 1, wherein the customer equipment comprises a residential gateway.

51. The method defined in claim 1, wherein the customer equipment comprises a cellular telephone.

52. The method defined in claim 1, further comprising:
collecting second user data;
storing the second user data in the memory;
scheduling execution of a second data send application at a second time later than the current time, the second data send application comprising computer-readable instructions for causing transmission of the second user data to the host.

53. The method of claim 52, further comprising downloading the second data send application into the memory.

54. The method defined in claim 52, wherein the second data send application resides in the memory before the second user data is collected.

55. The method defined in claim 52, wherein the first and second data send applications are stored in separate portions of the memory.

56. The method defined in claim 55, wherein the first and second user data are stored in separate portions of the memory.

57. The method defined in claim 56, the times at which the first and second data send applications are scheduled for execution being different from one another.

58. The method defined in claim 56, further comprising selecting the times at which the first and second data send applications are scheduled for execution.

59. A method for execution by a plurality of customer devices capable of communication with respective users, the method comprising:
collecting respective user data from the respective users;
storing the respective user data in respective memories;
scheduling execution of respective data send applications at respective execution times, the respective data send applications comprising respective computer-readable instructions for causing transmission of the respective user data to a host.

60. The method defined in claim 59, wherein at least two of the respective execution times are different.

61. The method defined in claim 59, wherein the respective execution times are distributed over a time interval greater than one minute.

62. The method defined in claim 59, wherein the respective execution times are distributed over a time interval greater than one hour.

63. The method defined in claim 59, wherein the respective execution times occur during a period of time that is associated with low usage of the customer equipment.

64. The method defined in claim 59, wherein the respective execution times occur during a period of time that is associated with low usage of the host.

65. Computer-readable media tangibly embodying instructions for execution by a control unit in a customer device to perform a method, the control unit having access to a memory, the method comprising:
collecting user data;
storing the user data in the memory;
scheduling execution of a data send application at a time later than the current time, the data send application comprising second computer-readable instructions for causing transmission of the user data to a host.

66. The method defined in claim 65, further comprising receiving and storing the data send application into the memory.

67. A customer device, comprising:
a user interface for collecting user data from a user of the customer device;
a memory;
a control unit adapted to execute computer-readable instructions for:
storing the collected user data into the memory;
scheduling execution of the data send application at a time later than the current time.

68. The customer device defined in claim 67, further comprising a receive interface capable of receiving the data send application from a control center.

69. The customer device defined in claim 68, wherein the control unit is further adapted to executed computer-readable instructions for storing the received data send application into the memory.

70. The customer device defined in claim 67, wherein the data send application comprises computer-readable instructions for causing transmission of the user data to the host.

71. The customer device defined in claim 70, further comprising a modem, wherein the transmission of the user data to the host is effected using the modem.

72. The customer device defined in claim 71, wherein the memory comprises a plurality of memory blocks, wherein the data send application resides in a pre-determined one of said memory blocks.

73. The customer device defined in claim 72, wherein the control unit is further adapted to execute computer-readable instructions for submitting a visual query to the user of the customer premises.

74. The customer device defined in claim 73, wherein the computer-readable instructions for submitting a visual query to the user of the customer premises are effected prior to the computer-readable instructions for storing the collected user data into the memory.

75. The customer device defined in claim 74, wherein the control unit is further adapted to execute computer-readable instructions for validating the data send application.

76. The customer device of claim 67, wherein the receive interface comprises a satellite dish in conjunction with a tuner.

77. The customer device of claim 67, being a set top box.

78. The customer device of claim 67, being a residential gateway.

79. The customer device of claim 67, being a cellular telephone.
